(19) United States
(12) Patent Application Publication
(10) Pub. No.: US 2012/0220678 A1
(43) Pub. Date: Aug. 30, 2012

(54) THERMOPLASTIC COMPOSITIONS HAVING IMPROVED FLOWABILITY

(76) Inventors: Christof Mehler, Dossenheim (DE); Rolf Minkwitz, Mannheim (DE); Christian Schade, Ludwigshafen (DE); Piyada Charoensirisomboon, Mannheim (DE); Norbert Niessner, Friedelsheim (DE); Kyung Ho Shon, Nam ku (KR)

(21) Appl. No.: 13/505,966

(22) PCT Filed: Nov. 2, 2010
(86) PCT No.: PCT/EP2010/066574

§ 371 Date: May 3, 2012

(30) Foreign Application Priority Data
Nov. 3, 2009 (EP) 09174900.2

(51) Int. Cl. C08K 5/12; C08J 9/22; C08L 55/02

(52) U.S. Cl. 521/139; 524/285

(57) ABSTRACT

The present invention relates to compositions comprising
(i) as component (I), at least one molding composition comprising components A and B, where
   A) is a graft copolymer as component A, and
   B) is a thermoplastic copolymer as component B; and
(ii) at least one cyclohexanepolycarboxylic acid derivative of the formula (I); as component (II)

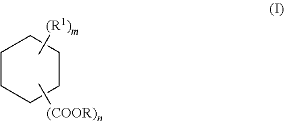

in which
R¹ is C₁-C₁₀-alkyl or C₃-C₈-cycloalkyl,
m is 0, 1, 2, or 3,
n is 2, 3, or 4, and
R is hydrogen or C₁-C₃₀-alkyl;
   or
   the group —(COOR)ₙ forms an anhydride of the formula

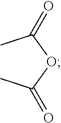

where it is essential to the invention that component (I) comprises from 11 to 19.9% by weight of component A and from 80.1 to 89% by weight of component B, where each of the % by weight values is based on the entirety of components A and B, and the total of those values is 100% by weight,
and also to a process for producing the composition of the invention, to the use of the composition of the invention for producing moldings, foils, foams, or fibers, and to moldings, foils, foams, or fibers comprising the composition of the invention.

### DESCRIPTION

The present invention relates to compositions comprising
(i) as component (I) at least one molding composition comprising components A and B, where
   A) is a graft copolymer as component A, comprising
   a1) from 30 to 90% by weight, based on component A, of a graft base obtainable via reaction of
   a1.1) from 50 to 100% by weight, based on component a1, of at least one conjugated diene, and
   a1.2) from 0 to 50% by weight, based on component at of at least one further monoethylenically unsaturated monomer, and
   a2) from 10 to 70% by weight, based on component A, of a graft obtainable via reaction of
   a2.1) from 60 to 95% by weight, based on component a2, of at least one vinylaromatic monomer, particularly preferably styrene and/or α-methylstyrene,
   a2.2) from 5 to 40% by weight, based on component a2, of acrylonitrile, and
   a2.3) from 0 to 35% by weight, based on component a2, of at least one further monoethylenically unsaturated monomer
   in the presence of the graft base a1, and
   B) is a thermoplastic copolymer as component B obtainable via reaction of
   b1) from 60 to 100% by weight, based on component B, of at least one vinylaromatic monomer, particularly preferably styrene and/or α-methylstyrene,
   b2) from 0 to 40% by weight, based on component B, of acrylonitrile, and
   b3) from 0 to 40% by weight, based on component B, of at least one further monoethylenically unsaturated monomer;
(ii) at least one cyclohexanepolycarboxylic acid derivative of the formula (I); as component (II)

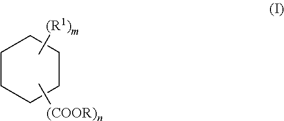

35
in which
R¹ is C₁-C₁₀-alkyl or C₃-C₈-cycloalkyl,
m is 0, 1, 2, or 3,
n is 2, 3, or 4, and
R is hydrogen or C₁-C₃₀-alkyl;
or
the group —(COOR)ₙ forms an anhydride of the formula

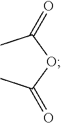

(iii) as component Op, if appropriate, one or more further polymers;

(iv) as component (IV), if appropriate, one or more additives; and

(v) as component (V), if appropriate, one or more fillers and/or reinforcing materials, to a process for producing the composition of the invention, to the use of the composition of the invention for producing moldings, foils, foams, or fibers, and to moldings, foils, foams, or fibers comprising the composition of the invention.

The prior art discloses numerous compositions based on styrene-acrylonitrile copolymers (SAN), or based on the acrylonitrile-butadiene-styrene copolymers (ABS) that have been impact-modified with a butadiene rubber, and describes various applications of said compositions.

By way of example, DE 20 2007 016 189 U1 discloses mixtures made of ABS, a phthalate having an aliphatic alcohol component, and at least one further copolymer, where these have improved processing properties in respect of viscosity and impact resistance. No further detail is given in relation to the ABS, in particular the rubber content thereof.

WO 00/78853 Al describes the use of cyclohexanepolycarboxylic acids and derivatives thereof as plasticizers in plastics, where said cyclohexane polycarboxylic acids and derivatives thereof are preferable to phthalates for reasons of toxicology. That specification gives no detailed information about the actual plastics.

European patent application 08165358.6 (file reference) describes compositions based on acrylonitrile-styrene-acrylate copolymers (ASA), ABS, or SAN, where these comprise at least one cyclohexane polycarboxylic acid derivative and at least one wax, and can be processed with minimum energy usage. According to said specification, the graft rubber content is from 10 to 80% by weight, preferably from 20 to 70% by weight, particular preferably from 25 to 60% by weight, based on the total weight of graft rubber and thermoplastic copolymer. The examples disclosed in that specification use ASA.

The compositions described in the prior art are suitable inter alia for producing moldings, for example by the injection-molding process. Here, it is particularly desirable, when producing thin-walled and/or large-surface-area moldings, to have access to free-flowing molding compositions, while the resultant moldings are generally intended to have maximum mechanical stability and high toughness. A further intention is that no additives migrate to the surface of the molding during or after production of the moldings.

It was therefore an object of the present invention to provide compositions which are based on styrene copolymers and on plasticizers free from toxicological hazards and which exhibit the following differences from the molding compositions described in the prior art: improved flowability in the production of moldings, good or improved mechanical properties, and/or no migration of the plasticizer to the surface of corresponding moldings even at elevated temperature.

This object is achieved via the abovementioned compositions, where it is essential to the invention that component (I) comprises from 11 to 19.9% by weight of component A and from 80.1 to 89% by weight of component B, where each of the % by weight values is based on the entirety of components A and B, and the total of those values is 100% by weight.

The compositions of the invention, comprising the specifically selected quantitative proportions of components A and B, and also component II, exhibit the following differences from the comparable molding compositions described in the prior art: improved flowability in the production of moldings, good or improved mechanical properties, and/or no migration of the plasticizer to the surface of corresponding moldings even at elevated temperature.

A more detailed description of the invention now follows.

The compositions of the invention generally comprise
(i) from 95 to 99.99% by weight, preferably from 96 to 99.9% by weight, particularly preferably from 97 to 99.5% by weight, of component (I); and
(ii) from 0.01 to 5% by weight, preferably from 0.1 to 4% by weight, particularly preferably from 0.5 to 3% by weight, of component (II);
   where each of the percentage by weight values is based on the total weight of components I and II, and the total of those values is 100% by weight; and
(iii) from 0 to 50% by weight, preferably from 0 to 20% by weight, particularly preferably from 0.05 to 15% by weight, based in each case on the total weight of components I and II, of component (Ill);
(iv) from 0 to 50% by weight, preferably from 0 to 40% by weight, particularly preferably from 0.05 to 30% by weight, based in each case on the total weight of components I and II, of component (IV); and
(v) from 0 to 50% by weight, preferably from 0 to 40% by weight, particularly preferably from 0.05 to 30% by weight, based in each case on the total weight of components I and II, of component (V).

Component (I)

Component (I) comprised in the compositions of the invention comprises components A and B, where
A) is a graft copolymer as component A, comprising
a1) from 30 to 90% by weight, based on component A, of a graft base obtainable via reaction of
a1.1) from 50 to 100% by weight, based on component a1, of at least one conjugated diene, and
a1.2) from 0 to 50% by weight, based on component a1, of at least one further monoethylenically unsaturated monomer, and
a2) from 10 to 70% by weight, based on component A, of a graft obtainable via reaction of
a2.1) from 60 to 95% by weight, based on component a2, of at least one vinylaromatic monomer, particularly preferably styrene and/or α-methylstyrene,
a2.2) from 5 to 40% by weight, based on component a2, of acrylonitrile, and
a2.3) from 0 to 35% by weight, based on component a2, of at least one further monoethylenically unsaturated monomer
   in the presence of the graft base a1, and
B) is a thermoplastic copolymer as component B obtainable via reaction of
b1) from 60 to 100% by weight, based on component B, of at least one vinylaromatic monomer, particularly preferably styrene and/or α-methylstyrene,
b2) from 0 to 40% by weight, based on component B, of acrylonitrile, and
b3) from 0 to 40% by weight, based on component B, of at least one further monoethylenically unsaturated monomer;
   where it is essential to the invention that component (I) comprises from 11 to 19.9% by weight of component A and from 80.1 to 89% by weight of component B, where each of these % by weight values is based on the entirety of components A and B, and the total of those values is 100% by weight.

Component (I) Comprises

from 11 to 19.9% by weight, preferably from 15 to 19.5% by weight, particularly preferably from 17 to 19.3% by weight, of component A and from 80.1 to 89% by weight, preferably from 80.5 to 85% by weight, particularly preferably from 80.7 to 83% by weight, of component B,

where each of the % by weight values is based on the entirety of components A and B, and the total of those values is 100% by weight.

For the purposes of the present application, the expression (meth)acrylic acid or, respectively, (meth)acrylate used hereinafter means acrylic acid and/or methacrylic acid or, respectively, acrylate and/or methacrylate.

The graft copolymer A comprises

as graft base from 30 to 90% by weight, preferably from 40 to 80% by weight, particularly preferably from 45 to 70% by weight, of component a1, and

as graft (graft shell) from 10 to 70% by weight, preferably from 20 to 60% by weight, particularly preferably from 30 to 55% by weight, of component a2

(where each of the % by weight values is based on the weight of component A, and the total of those values is 100% by weight).

The graft base a1 is obtainable via reaction of

from 50 to 100% by weight, preferably from 70 to 100% by weight, particularly preferably from 85 to 100% by weight, of component a1.1, and

from 0 to 50% by weight, preferably from 0 to 30% by weight, particularly preferably from 0 to 15% by weight, of component a1.2 (where each of the % by weight values is based on the weight of component a1, and the total of those values is 100% by weight).

The graft a2 is obtainable via reaction of

from 60 to 95% by weight, preferably from 65 to 80% by weight, particularly preferably from 70 to 75% by weight, of component a2.1,

from 5 to 40% by weight, preferably from 20 to 35% by weight, particularly preferably from 25 to 30% by weight, of component a2.2, and

from 0 to 35% by weight, preferably from 0 to 15% by weight, particularly preferably from 0 to 5% by weight, of component a2.3 (where each of the % by weight values is based on the weight of component a2, and the total of those values is 100% by weight), in the presence of the graft base a1.

The thermoplastic copolymer B is obtainable via reaction of

from 60 to 100% by weight, preferably from 60 to 85% by weight, particularly preferably from 65 to 82% by weight, of component b1,

from 0 to 40% by weight, preferably from 15 to 40% by weight, particularly, preferably from 18 to 35% by weight, of component b.2, and

from 0 to 40% by weight, preferably from 0 to 25% by weight, particularly preferably from 0 to 17% by weight, of component b.3 (where each of the % by weight values is based on the weight of component B, and the total of those values is 100% by weight).

The invention can use one or more conjugated dienes as component a1.1.

Conjugated dienes preferably used as components a1.1 are butadiene, isoprene, chloroprene, or a mixture of these. It is preferable to use 1,3-butadiene or isoprene or a mixture of these, and it is particularly preferable to use 1,3-butadiene.

Examples of further monoethylenically unsaturated monomers a1.2 that can be used are:

vinylaromatic monomers, such as styrene or styrene derivatives, e.g. C₁-C₈-alkylstyrene, such as α-methylstyrene, acrylonitrile, methacrylonitrile; and also the glycidyl esters glycidyl acrylate and glycidyl methacrylate; N-substituted maleimides, e.g. N-methyl-, N-phenyl-, and N-cyclohexylmaleimide; acrylic acid; methacrylic acid; and also dicarboxylic acids, such as maleic acid; nitrogen-functional monomers, such as dimethylaminoethyl acrylate, diethylaminoethyl acrylate; vinylimidazole, vinylpyrrolidone, vinylcaprolactam, vinylcarbazole, vinylaniline; aliphatic, aromatic, and araliphatic esters of acrylic acid and methacrylic acid, e.g. methyl(meth)acrylate, n-butyl (meth)acrylate, phenyl acrylate, phenyl methacrylate, benzyl acrylate, benzyl methacrylate, 2-phenylethyl acrylate, 2-phenylethyl methacrylate, 2-phenoxyethyl acrylate, and 2-phenoxyethyl methacrylate; unsaturated ethers, such as vinyl methyl ether; and also mixtures of two or more of said monomers. Preferred monomers a1.3 are styrene, α-methylstyrene, acrylonitrile, glycidyl acrylate or glycidyl methacrylate or a mixture thereof, in particular styrene.

In another preferred embodiment, a graft base is produced from, based on a1),

a1.1) 100% by weight of butadiene or

a1.1) from 70 to 99.9% by weight, preferably from 90 to 99% by weight, of butadiene, and

a1.2) from 0.1 to 30% by weight, preferably from 1 to 10% by weight, of styrene.

Component a2.1 used is generally styrene, α-methylstyrene, or a mixture of these compounds, preferably styrene.

Component a.2.2 is acrylonitrile.

In principle, any unsaturated monomers that differ from components a2.1 and a2.2 can be used as component a2.3. Examples of suitable compounds are the monoethylenically unsaturated monomers previously mentioned as component a1.2 (with the exception of styrene, α- methylstyrene, and acrylonitrile), preference being given here to methyl methacrylate, glycidyl acrylate, or glycidyl methacrylate.

Component b1 used is generally styrene, α-methylstyrene, or a mixture of these compounds, preferably styrene.

Component b2 is acrylonitrile.

The unsaturated monomers previously mentioned as component a2.3 are suitable as component b3.

Preferred components B are polystyrene, SAN, poly-a-methylstyrene-acrylonitrile, or a mixture of these.

Component A is a graft copolymer comprising a graft base a1 and at least one graft a2. The graft copolymer A can have a relatively perfect core-shell structure (graft base a1 being the core, and graft a2 being the shell), but it is also possible that the graft a2 only incompletely encloses or covers the graft base a1, or else that there is full or partial puncture of the graft a2 by the graft base a1.

In one embodiment of the invention, the graft base a1 can comprise what is known as a core which can be composed of a soft elastomeric polymer or of a hard polymer; in the embodiments in which the graft base a1 comprises a core, the core is preferably formed from a hard polymer, in particular polystyrene, or from a styrene copolymer. These graft cores and their preparation are known to the person skilled in the art and are described by way of example in EP-A 535456 and EP-A 534212.

It is, of course, also possible to use two or more graft bases a1, differing from one another by way of example in their constitution or in particle size. These mixtures of different graft bases can be produced by methods known per se to the person skilled in the art, for example by separately producing two or more rubber latices and mixing the corresponding dispersions, separately precipitating the moist rubbers from the corresponding dispersions and, by way of example, mixing them in an extruder, or carrying out the entire work-up of the corresponding dispersions separately and then mixing the resultant graft bases.

The graft copolymer A can have one or more further grafts or graft shells between the graft base a1 and the graft a2—for example with other monomer compositions—but the graft copolymer A preferably has no grafts or graft shells other than the graft a2.

The glass transition temperature of the polymer of the graft base a1 is usually below 0° C., preferably below −20° C., in particular below −30° C. A polymer composed of the monomers forming the graft a2 usually has a glass transition temperature above 30° C., in particular above 50° C. (in each case determined to DIN 53765).

The average particle size d₅₀ of the graft copolymers A is usually from 50 to 1200 nm, preferably from 50 to 1000 nm, and particularly preferably from 50 to 850 nm. These particle sizes can be achieved by using, as graft base a1, particles whose size is from 50 to 1000 nm, preferably from 50 to 700 nm, and particularly preferably from 50 to 600 nm. According to one embodiment of the invention, the particle size distribution is monomodal.

According to another inventive embodiment, the particle size distribution of component A is bimodal, the average particle size of from 60 to 90% by weight being from 50 to 200 nm and the average particle size of from 10 to 40% by weight being from 200 to 850 nm, based on the total weight of component A.

The average particle size and particle size distribution given are the sizes determined from the cumulative weight distribution. These average particle sizes and further average particle sizes mentioned in the context of the present invention are in all cases the weight average of the particle sizes, and the determination of these is based on the method of W. Scholtan and H. Lange, Kolloid-Z. and Z.-Polymere 250 (1972), pp. 782-796, using an analytical ultracentrifuge.

The preparation of component (I) comprises at least the following steps in a process:

The graft base a1 can be produced via emulsion, solution, bulk, or suspension polymerization of components a1.1 and a1.2, application of a graft a2 via polymerization of components a2.1, a2.2, and a2.3 in the presence of the graft base a1, and mixing in the melt of the graft copolymer A with a separately produced thermoplastic copolymer B.

These steps in a process, and also the optional further steps described at a later stage below, can be carried out by methods known per se to the person skilled in the art and/or described in the literature.

The graft copolymers A can be produced via graft polymerization of components a2.1, and, if appropriate, a2.2 and, if appropriate, a2.3, to at least one of the graft bases a1 listed above.

Suitable preparation processes for graft copolymers A are emulsion, solution, bulk, or suspension polymerization. The graft copolymers A are preferably produced by free-radical emulsion polymerization in the presence of latices of component a1 at temperatures of from 20° C. to 90° C., using water-soluble or oil-soluble initiators, such as peroxodisulfate or benzyl peroxide, or with the aid of redox initiators. Redox initiators are also suitable for polymerization below 20° C.

Suitable polymerization processes are described by way of example in WO 02/10222, DE-A 28 26 925 and 31 49 358, and DE-C 12 60 135.

The grafts are preferably built up in the emulsion polymerization process described by way of example in DE-A 32 27 555, 31 49 357, 31 49 358, 34 14 118. The defined setting of the particle sizes of the invention preferably takes place by the processes described in DEC 12 60 135 and DE-A 28 26 925, and Applied Polymer Science, volume 9 (1965), p. 2929. The use of polymers with different particle sizes is known from DE-A 28 26 925 and U.S. Pat. No. 5 196 480, for example.

By analogy with the process described in DE-C 12 60 135, the graft base a1 is first produced by polymerizing the dienes a1.1, if appropriate together with the further monoethylenically unsaturated monomers a1.2, in aqueous emulsion, in a manner known per se at temperatures of from 20 to 100° C., preferably from 50 to 90° C. Use may be made of the usual emulsifiers, such as alkali metal alkyl- or alkylarylsulfonates, alkyl sulfates, fatty alcohol sulfonates, salts of higher fatty acids having from 10 to 30 carbon atoms, or resin soaps. It is preferable to use the sodium salts of alkylsulfonates or fatty acids having from 10 to 18 carbon atoms. According to one embodiment, the amounts used of the emulsifiers are from 0.5 to 5% by weight, in particular from 0.7 to 2% by weight, based on the monomers used in preparation of the graft base a1. Operations are generally carried out with a water:monomers weight ratio of from 4:1 to 0.6:1. The polymerization initiators used are in particular the commonly used persulfates, such as potassium persulfate. However, it is also possible to use redox systems. The amounts generally used of the initiators are from 0.1 to 1% by weight, based on the monomers used in preparation of the graft base a1. Other polymerization auxiliaries that can be used during the polymerization reaction are the usual buffer substances which can set a preferred pH of from 6 to 9, examples being sodium bicarbonate and sodium pyrophosphate, and also from 0 to 3% by weight of a molecular weight regulator, such as mercaptans, terpinols, or dimeric α-methylstyrene.

The precise polymerization conditions, in particular the nature, feed parameters, and amount of the emulsifier, are determined individually within the ranges given above in such a way that the d₅₀ of the resultant latex of the diene polymer a1 is in the range from about 50 to 1000 nm, preferably from 50 to 700 nm, particularly preferably in the range from 50 to 600 nm. The particle size distribution of the latex here is preferably to be narrow.

In a subsequent step, in order to produce the graft polymer A, according to one embodiment of the invention, a monomer mixture composed of component a2.1, preferably styrene, component a2.2, acrylonitrile, and, if appropriate, component a2.3 is polymerized in the presence of the resulting latex of the diene polymer a1. The monomers a2.1, a2.2, and, if appropriate, a2.3 can be added here individually or in a mixture with one another. By way of example, styrene can first be grafted alone, followed by a mixture composed of styrene and acrylonitrile. Again, it is advantageous for this graft copolymerization reaction onto the diene polymer serving as graft base to be carried out in aqueous emulsion under the conventional conditions described above. The system in which the graft copolymerization reaction takes place can advantageously be identical with that in which the emulsion polymerization reaction takes place for preparation of the graft base a1, and, if necessary, further emulsifier and initiator can be added here. The monomer mixture to be applied by grafting according to one embodiment of the invention can be added to the reaction mixture all at once, batchwise in two or more stages—for example to construct two or more grafts—or preferably continuously during the polymerization reaction. The control of the graft yield in the graft copolymerization reaction, and therefore of the degree of grafting of the finished graft copolymer A, is a matter familiar to the person skilled in the art and can by way of example be achieved inter alia via the rate of metering of the monomers or via addition of regulator (Chauvel, Daniel, ACS Polymer Preprints 15 (1974), pp. 329 ff.). The emulsion graft copolymerization reaction generally produces about 5-15% by weight, based on the graft copolymer, of free, ungrafted copolymer of components a2.1, a2.2 and, if appropriate, a2.3. The proportion of the graft copolymer A in the polymerization product obtained during the graft copolymerization reaction can by way of example be determined by the method described in US-A 2004/0006178.

In further embodiments of the processes of the invention, the graft base a1 can be prepared in the presence of seed particles, and/or an agglomeration step can be carried out after the preparation of the graft base a1 and prior to application of the graft a2. These two process options are known to the person skilled in the art and/or are described in the literature, and are selected in order, for example, to obtain specific adjustment of particle sizes and particle size distributions.

The d₅₀ particle size of seed particles is generally from 10 to 200 nm, preferably from 10 to 180 nm, particularly preferably from 10 to 160 nm. The particle size distribution of the seed particles used is preferably very small. Particularly preferred seed particles among these are those whose particle size distribution is monomodal.

The seed particles can in principle be composed of monomers that form elastomeric polymers, for example 1,3-butadiene, or of a polymer whose glass transition temperature is more than 0° C., preferably more than 25° C.

Preparation of these seed particles is known to the person skilled in the art or can be carried out by methods known per se. The seed particles are preferably obtained via particle-forming heterogeneous polymerization processes, preferably via emulsion polymerization. According to the invention, the seed particles are used as initial charge, and it is possible here to begin with separate preparation and work-up of the seed particles, and then to use them. However, it is also possible to prepare the seed particles and then, without prior work-up, to add to these the monomer mixture of a1.1 and, if appropriate, a.1.2.

Processes for partial or complete agglomeration of the graft base a1 are known to the person skilled in the art, or agglomeration can be undertaken by methods known per se to the person skilled in the art (see, for example, Keppler et al. Angew. Makromol. Chemie, 2, 1968 No. 20, pp. 1-25). There is in principle no restriction on the agglomeration method. By way of example, physical processes can be used, such as freeze agglomeration or pressure agglomeration processes. However, chemical methods can also be used to agglomerate the graft base. Among the latter are addition of electrolytes or of inorganic or organic acids. Preference is given to agglomeration undertaken by means of an agglomeration polymer. Examples of these are polyethylene oxide polymers, polyvinyl ethers, or polyvinyl alcohols.

Among the suitable agglomeration polymers are moreover copolymers in which C1-C12-alkyl acrylates or C1-C12-methalkyl acrylates and polar comonomers, such as acrylamide, methacrylamide, ethacrylamide, n-butylacrylamide, maleamide, or (meth)acrylic acid are present. Among other monomers which can be present alongside these monomers in these copolymers are dienes, such as butadiene or isoprene.

The agglomeration polymers can have a multistage structure and can have, for example, a core-shell structure. Examples of a core used are polyacrylates, such as polyethyl acrylate, and particles on (meth)alkyl acrylates and on the polar comonomers mentioned can be used as shell. A particularly preferred agglomeration polymer is a copolymer composed of from 92 to 99% by weight of ethyl acrylate or of ethyl methacrylate and from 1 to 8% by weight of (meth)acrylamide and/or (meth)acrylic acids. The agglomeration polymers are generally used in the form of a dispersion. From 0.1 to 5 parts by weight, preferably from 0.5 to 3 parts by weight, of the agglomeration polymers are generally used in the agglomeration process for every 100 parts by weight of the graft base.

The inventive graft copolymers A can be further used in the form in which they are produced in the reaction mixture, for example in the form of latex emulsion or of latex dispersion. As an alternative, which is preferable for most applications, they can also, however, be worked up in a further step. Measures for work-up are known to the person skilled in the art. An example among these is isolation of the graft copolymers A from the reaction mixture, e.g. via spray drying or shear, or via precipitation using strong acids, or by means of nucleating agents, such as inorganic compounds, e.g. magnesium sulfate. However, the graft copolymers A present in the reaction mixture can also be worked up by dewatering them completely or partially. Another possibility is to undertake the work-up by means of a combination of the measures mentioned.

The thermoplastic copolymers B can be prepared by processes known per se, for example via bulk, solution, suspension, or emulsion polymerization, preferably via solution polymerization (see GB-A 14 72 195). Preference is given here to copolymers B having molar masses M_{w} of from 60 000 to 300 000 g/mol, determined via light scattering in dimethylformamide. In one preferred embodiment of the invention, component B is prepared, then isolated by processes known to the person skilled in the art, and preferably processed to give pellets.

Component (II)

The compositions of the invention have, as component (II), at least one cyclohexanepolycarboxylic acid derivative of the formula (I):

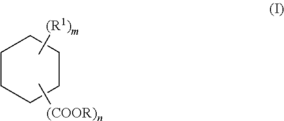

in which

R¹ is C₁-C₁₀-alkyl or C₃-C₈-cycloalkyl,

m is 0, 1, 2, or 3,

n is 2, 3, or 4, and

R is hydrogen or C₁-C₃₀-alkyl, preferably C₁-C₂₀-alkyl, particularly preferably C₁-C₁₈-alkyl, very particularly preferably C₁-C₁₃-alkyl, in particular C₈-C₁₃-alkyl, where at least one radical R is C₁-C₃₀-alkyl, preferably C₁-C₂₀-alkyl, particularly preferably C₁-C₁₈-alkyl, very particularly preferably C₁-C₁₃-alkyl, in particular C₈-C₁₃-alkyl, or

the group —(COOR)ₙ forms an anhydride of the formula

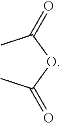

The cyclohexanepolycarboxylic acid derivatives comprised in the invention in particular involve mono-, di-, tri-, and tetraesters and anhydrides of cyclohexanepolycarboxylic acids. It is preferable that all of the carboxylic acid groups have been esterified, i.e. R is preferably C₁-C₃₀-alkyl. The C₁-C₃₀-alkyl radical can be linear, branched, or—in the case of an alkyl radical having from 3 to 30 carbon atoms—cyclic. The C₁-C₃₀-alkyl radical can moreover by way of example have substitution by C₁-C₁₀-alkoxy groups. It is particularly preferable that the C1-C30-alkyl radical involves a linear or branched alkyl radical which comprises from 1 to 30, preferably from 1 to 20, particularly preferably from 1 to 18, very particularly preferably from 1 to 13, in particular from 8 to 13, carbon atoms,

The C₁-C₃₀-alkyl radical, preferably C₁-C₂₀-alkyl radical, particularly preferably C₁-C₁₈-alkyl radical, very particularly preferably C₁-C₁₃-alkyl radical, in particular C₈-C₁₃-alkyl radical (radical R in the cyclohexanepolycarboxylic acid derivative of the formula (I)) can moreover involve mixtures of various alkyl radicals which differ in the number of carbon atoms and/or in their degree of branching. By way of example, the isononyl, isodecyl, isoundecyl, isododecyl, and isotridecyl radicals mentioned below involve mixtures of variously branched alkyl radicals, as is known to the person skilled in the art. In principle, the compounds in this case always involve various cyclohexanepolycarboxylic acid derivatives of the formula (I) which differ in their alkyl radicals R, e.g. in the number of carbon atoms and/or in the degree of branching of the alkyl radicals. It is also possible in a cyclohexanepolycarboxylic acid derivative of the formula (I) that—for the case where n≧2—the n radicals R can be different (mixed esters) (or identical).

R is preferably C₁-C₂₀-alkyl, particularly preferably C₁-C₁₈-alkyl, very particularly preferably C₁-C₂₀-alkyl, with very particular preference C₁-C₁₈-alkyl, with further very particular preference C₁-C₁₃-alkyl, and in particular C₈-C₁₃-alkyl. Examples of these alkyl groups are methyl, ethyl, n-propyl, isopropyl, n-butyl, isobutyl, sec-butyl, tert-butyl, n-pentyl, n-hexyl, n-octyl, 2-ethylhexyl, n-nonyl, isononyl, n-decyl, isodecyl, n-undecyl, isoundecyl, n-dodecyl, isododecyl, n-tridecyl, isotridecyl, stearyl, and n-eicosyl. Very particularly preferred alkyl groups R are 2-ethylhexyl, isononyl, and isodecyl.

n is very particularly preferably 2.

If m is 2 or 3, the radicals R¹ can be identical or different. The C₁-C₁₀-alkyl groups and the C₁-C₃₀-alkyl groups can be straight-chain or branched groups. If R¹ is an alkyl group, this preferably involves a C₁-C₈-alkyl group, particularly preferably a C₁-C₆-alkyl group. Examples of these alkyl groups are methyl, ethyl, n-propyl, isopropyl, n-butyl, isobutyl, sec-butyl, tert-butyl, n-pentyl, n-hexyl, n-octyl, and 2-ethylhexyl.

m is very particularly preferably 0.

It is preferable that the at least one cyclohexanepolycarboxylic acid derivative has been selected from the group consisting of ring-hydrogenated mono- and dialkyl esters of phthalic acid, isophthalic acid, and terephthalic acid, of ring-hydrogenated mono-, di-, and trialkyl esters of trimellitic acid, of trimesic acid, and of hemimellitic acid, or of mono-, di-, tri-, and tetraalkyl esters of pyromellitic acid, where the alkyl groups can be linear or branched groups and in each case have from 1 to 30, preferably from 2 to 10, particularly preferably from 3 to 18, carbon atoms, and of mixtures composed of two or more of these.

Suitable cyclohexanepolycarboxylic acid derivatives are disclosed by way of example in WO99/32427.

Particular preference is given to alkyl cyclohexane-1,2-dicarboxylates, alkyl cyclohexane-1,3-dicarboxylates, and alkyl cyclohexane-1,4-dicarboxylates, i.e. n in formula (I) is very particularly preferably 2, and the arrangement has the 2 groups COOR in ortho-, meta-, or para-position in respect of one another. Suitable radicals R have been mentioned above.

Suitable cyclohexanepolycarboxylic acid derivatives are in particular the cyclohexane-1,2-dicarboxylic esters disclosed in WO 99/32427 and again listed below:

mixed esters of cyclohexane-1,2-dicarboxylic acid with C1-C13 alcohols;

di(isopentyl)cyclohexane-1,2-dicarboxylate, obtainable via hydrogenation of di(isopentyl)phthalate with the Chemical Abstracts Registry Number (hereinafter: CAS No.) 84777-06-0;

di(isoheptyl) cyclohexane-1,2-dicarboxylate, obtainable via hydrogenation of di(isoheptyl)phthalate with the CAS No. 71888-89-6;

di(isononyl)cyclohexane-1,2-dicarboxylate, obtainable via hydrogenation of a di(isononyl)phthalate with the CAS No. 68515-48-0;

di(isononyl)cyclohexane-1,2-dicarboxylate, obtainable via hydrogenation of a di(isononyl)phthalate with the CAS No. 28553-12-0, based on n-butene;

di(isononyl) cyclohexane-1,2-dicarboxylate, obtainable via hydrogenation of a di(isononyl) phthalate with the CAS No. 28553-12-0, based on isobutene;

a di-C9 ester of cyclohexane-1,2-dicarboxylic acid, obtainable via hydrogenation of a di(nonyl) phthalate with the CAS No. 68515-46-8;

a di(isodecyl) cyclohexane-1,2-dicarboxylate obtainable via hydrogenation of a di(isodecyl) phthalate with the CAS No. 68515-49-1;

a di-C7-11 ester of cyclohexane-1,2-dicarboxylic acid, obtainable via hydrogenation of the corresponding phthalic ester with the CAS No. 68515-42-4;

a di-C7-11 ester of cyclohexane-1,2-dicarboxylic acid, obtainable via hydrogenation of the di-C7-11 phthalates with the following CAS Nos.

111 381-89-6,

111 381 90-9,

111 381 91-0,

68515-44-6,

68515-45-7 and

3648-20-2;

a di-C9-11 ester of cyclohexane-1,2-dicarboxylic acid, obtainable via hydrogenation of a di-C9-11 phthalate with the CAS No. 98515-43-6;

a di(isodecyl) cyclohexane-1,2-dicarboxylate, obtainable via hydrogenation of a di(isodecyl) phthalate, composed mainly of di(2-propylheptyl) phthalate;

a di-C7-9 cyclohexane-1,2-dicarboxylate, obtainable via hydrogenation of the corresponding phthalic ester of the branched-chain or linear C7-9-alkyl ester groups;

corresponding phthalates that can be used by way of example as starting materials have the following CAS Nos.:

di-C7,9-alkyl phthalate with the CAS No. 111 381-89-6;

di-C7-alkyl phthalate with the CAS No. 68515-44-6; and

di-C9-alkyl phthalate with the CAS No. 68515-45-7.

The entire content of WO 99/32427 relating inter alia to these compounds listed immediately above and to the preparation of benzenepolycarboxylic acids using specific catalysts having macropores is incorporated into the present application by way of reference.

Other suitable cyclohexanepolycarboxylic acid derivatives, of the formula (I) are hydrogenation products of mixed phthalic esters with C10 and C13 alcohols, these being described in DE-A 10032580.7.

For the purposes of the present invention, the hydrogenation products of the commercially obtainable benzenecarboxylic esters with the following trade names are also to be regarded as suitable: Jayflex DINP (CAS No. 68515-48-0), Jayflex DIDP (CAS No. 68515-49-1), Palatinol 9-P, Vestinol 9 (CAS No. 28553-12-0), TOTM-I (CAS No. 3319-31-1), Linplast 68-TM, Palatinol N (CAS No. 28553-12-0), Jayflex DHP (CAS No. 68515-50-4), Jayflex DIOP (CAS No. 27554-26-3), Jayflex UDP (CAS No. 68515-47-9), Jayflex DIUP (CAS No. 85507-79-5), Jayflex DTDP (CAS No. 68515-47-9), Jayflex L9P (CAS No. 68515-45-7), Jayflex L911P (CAS No. 68515-43-5), Jayflex L11P (CAS No. 3648-20-2), Witamol 110 (CAS No. 90193-91-2), Witamol 118 (di-n-C8-C10-alkyl phthalate), Unimoll BB (CAS No. 85-68-7), Linplast 1012 BP (CAS No. 90193-92-3), Linplast 13 XP (CAS No. 27253-26-5), Linplast 610 P (CAS No. 68515-51-5), Linplast 68 FP (CAS No. 68648-93-1), and Linplast 812 HP (CAS No. 70693-30-0), Palatinol AH (CAS No. 117-81-7), Palatinol 711 (CAS No. 68515-42-4), Palatinol 911 (CAS No. 68515-43-5), Palatinol 11 (CAS No. 3648-20-2), Palatinol Z (CAS No. 26761-40-0), and Palatinol DIPP (CAS No. 84777-06-0).

Particularly suitable cyclohexanepolycarboxylic acid derivatives for the compositions of the invention are cyclohexane-1,2-dicarboxylic esters selected from the group consisting of diisobutyl cyclohexane-1,2-dicarboxylate, di(2-ethylhexyl)cyclohexane-1,2-dicarboxylate, diisononyl cyclohexane-1,2-dicarboxylate, and diisodecyl cyclohexane-1,2-dicarboxylate, very particular preference being given to di(2-ethylhexyl) cyclohexane-1,2-dicarboxylate and diisononyl cyclohexane-1,2-dicarboxylate, and very particular preference being given in particular to diisononyl cyclohexane-1,2-dicarboxylate. By way of example, the material involved can be diisononyl cyclohexane-1,2-dicarboxylate (diisononyl cyclohexane-1,2-dicarboxylate) which is also obtainable commercially as Hexamoll® DINCH (BASF SE).

The cyclohexanepolycarboxylic acid derivatives are preferably produced by the process disclosed in WO 99/32427. Said process comprises the hydrogenation of a benzenepolycarboxylic acid or of a derivative thereof, or of a mixture composed of two or more thereof, by bringing the benzenepolycarboxylic acid or the derivative thereof, or the mixture composed of two or more thereof, into contact with a gas comprising hydrogen, in the presence of a catalyst which comprises, as active metal, at least one metal of the 8th transition group of the Periodic Table of the Elements, alone or together with at least one metal of the 1st or 7th transition group of the Periodic Table of the Elements, applied to a support, where the support has macropores.

The hydrogenation of the benzenepolycarboxylic acid or of a derivative thereof, or of a mixture composed of two or more thereof, is generally carried out at a temperature of from 50 to 250° C., preferably from 70 to 220° C., particularly preferably from 80 to 170° C. The pressures used here are generally 10 bar, preferably from 20 to 300 bar.

The process of the invention can be carried out either continuously or batchwise, preference being given here to the continuous conduct of the process.

In the case of continuous conduct of the process, the amount of the benzenepolycarboxylic ester(s) and, respectively, of the mixture composed of two or more thereof, provided for the hydrogenation reaction, is preferably from 0.05 to 3 kg per liter of catalyst per hour, more preferably from 0.1 to 1 kg per liter of catalyst per hour.

Hydrogenation gases used can be any desired gases which comprise free hydrogen and which do not have damaging amounts of catalyst poisons, such as CO. By way of example, reformer exhaust gases can be used. The hydrogenation gas used is preferably pure hydrogen.

The hydrogenation reaction can be carried out in the absence or presence of a solvent or diluent, i.e. there is no requirement that the hydrogenation reaction be carried out in solution. The hydrogenation reaction can also, for example, be carried out in the gas phase.

However, it is preferable to use a solvent or diluent. The solvent or diluent used can comprise any suitable solvent or diluent. The selection here is not critical, as long as the solvent or diluent used is capable of forming a homogeneous solution with the benzenedicarboxylic acid (ester) to be hydrogenated. The solvents or diluents can by way of example also comprise water.

Examples of suitable solvents or diluents include the following: straight-chain or cyclic ethers, such as tetrahydrofuran or dioxane, and also aliphatic alcohols in which the alkyl radical preferably has from 1 to 10 carbon atoms, in particular from 3 to 6 carbon atoms. Examples of alcohols that can be used with preference are isopropanol, n-butanol, isobutanol, and n-hexanol. Mixtures of these or of other solvents or diluents can likewise be used.

There is no particular restriction on the amount of the solvent or diluent used, and it can be freely selected as required, but preferred amounts here are those which lead to a solution of strength from 10 to 70% by weight of the benzenedicarboxylic acid (ester) intended for the hydrogenation reaction. It is particularly preferable that the product formed in the hydrogenation reaction, i.e. the corresponding cyclohexane derivative, is used as solvent, if appropriate alongside other solvents or diluents. In all cases, a portion of the product formed in the process can be admixed with the remainder of the benzenepolycarboxylic acid to be hydrogenated or with the derivative thereof. Based on the weight of the compound provided for the hydrogenation reaction, it is preferable to admix from 1 to 30 times, particularly preferably from 5 to 20 times, in particular from 5 to 10 times, the amount of the reaction product as solvent or diluent.

In one preferred embodiment, the cyclohexanepolycarboxylic acid derivatives used in the compositions of the invention are produced by the following process:

Esterification of a benzenepolycarboxylic acid of the formula II

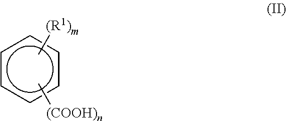

in which

R¹ is C₁-C₁₀-alkyl or C₃-C₈-cycloalkyl,

m is 0, 1, 2, or 3, and

n is 2, 3, or 4,

with one or more alcohols of the formula

R—OH

in which
R is C₁-C₃₀-alkyl, preferably C₁-C₂₀-alkyl, particularly preferably C₁-C₁₈-alkyl, very particularly preferably C₁-C₁₃-alkyl, in particular C₈-C₁₃-alkyl, giving a benzenepolycarboxylic ester of the formula III

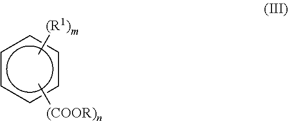

b) hydrogenation of the benzenepolycarboxylic ester of the formula III to give a corresponding cyclohexanepolycarboxylic ester.

Preferred embodiments of R¹, m, n, and R have been mentioned above in relation to the cyclohexanepolycarboxylic esters of formula I.

A preferred embodiment of the hydrogenation of the benzenepolycarboxylic ester of the formula III (step b)) has been mentioned above and is moreover described in the abovementioned document WO 99/32427.

Benzenepolycarboxylic acids whose use is preferred are phthalic acid, isophthalic acid, terephthalic acid, trimellitic acid, trimesic acid, hemimellitic acid, and pyromellitic acid. It is very particularly preferable to use phthalic acid. The abovementioned acids are obtainable commercially.

The alcohols used preferably comprise the alcohols corresponding to the radicals R of the cyclohexanepolycarboxylic acid derivatives of the formula I. It is therefore preferable to use linear or branched alcohols having C₁-C₁₃-alkyl radicals, particularly preferably having C₈-C₁₃-alkyl radicals. The alcohols R—OH used for the esterification reaction with the benzenepolycarboxylic acids can in each case involve the individual alcohol isomers corresponding to the abovementioned radicals R, or a mixture of various alcohols having isomeric alkyl radicals having the same number of carbon atoms, and/or a mixture of various alcohols with a different number of carbon atoms.

The alcohols or alcohol mixtures suitable for the reaction with the benzenepolycarboxylic acids can be prepared by any of the processes known to the person skilled in the art. Examples of processes suitable for the preparation of alcohols, or steps which are part of the process and which are applied during the preparation of alcohols, are:
hydroformylation with subsequent hydrogenation of the resultant aldehydes, for example as disclosed in WO 92/13818, DE-A 2 009 505, DE-A 199 24 339, EP-A 1 113 034, WO 00/63151, WO 99/25668, JP-A 1 160 928, JP-A 03 083 935, JP-A 2000/053803, EP-A 0 278 407, EP-A 1 178 029, FR-A 1 304 144, JP-A 30 44 340, JP-A 30 44 341, JP-A 30 44 342, JP-A 0 40 36 251, GB-A 721,540, DE-A 195 304 14, JP-A 2001/049029, U.S. Pat. No. 2,781,396, U.S. Pat. No. 3,094,564, FR-A 1 324 873, JP-A 0 816 9854, U.S. Pat. No. 3,153,673, U.S. Pat. No. 3,127,451, U.S. Pat. No. 1,828,344, WO 2003/66642, WO 2003/18912, EP-A 0 424 767, WO 2002/68369, EP-A 0 366 089, JP-A 2001/002829, DE-A 100 35 617, DE-A 199 55 593, WO 2002/00580, EP-A 0 643 031, U.S. Pat. No. 2,876,264, JP-A 2000/319444, and DE-A 100 32 580;
hydrogenation of aldol products, for example as disclosed in DE-A 102 51 311, JP-A 05 194 761, U.S. Pat. No. 3,272,873, DE-A 3 151 086, JP-A 2001/322959, WO 98/03462, and EP-A 0 603 630;
hydration of alkenes, for example as disclosed in U.S. Pat. No. 5,136,108, EP-A 0 325 144, EP-A 0 325 143, DE-A 100 50 627, U.S. Pat. No. 4,982,022, GB-A 2,187,741, DE-A 36 28 008, U.S. Pat. No. 3,277,191, JP-A 2000/191 566, DE-A 854 377, DE-A 38 01 275, DE-A 39 25 217, JP-A 06 321 828, JP-A 02 088 536, JP-A 06 287 156, JP-A 06 287 155, JP-A 54 141 712, JP-A 08 283 186, JP-A 09 263 558, and U.S. Pat. No. 4,684,751;
hydrogenation of carboxylic acids and of carboxylic esters, in particular fatty acids and fatty acid esters, for example as disclosed in U.S. Pat. No. 5,463,143, U.S. Pat. No. 5,475,159, WO 94/10112, CA 2,314,690, WO 94/06738, JP-A 06 065 125, and U.S. Pat. No. 3,361,832;
hydrogenation of unsaturated alcohols or of carbonyl compounds, for example as disclosed in EP-A 0 394 842, DE-A 1 269 605, WO 88/05767, FR-A 1,595,013, EP-A 0 326 674, BE-A 756 877, BE-A 757 561, DE-A 1 277 232, FR-A 1,499,041, and DE-A 1 276 620;
hydrogenation of epoxides, for example as disclosed in FR-A 1,508,939, GB-A 879 803, and DE-A 1 078 106;
processes comprising a telomerization step, for example as disclosed in EP-A 0 330 999, DE-A 1 138 751, U.S. Pat. No. 5,908,807, NE-6,603,884, and U.S. Pat. No. 3,091,628;
processes comprising an isomerization step, for example as disclosed in DE-A 42 28 887;
hydrolysis of sulfates, for example as disclosed in GB-A 1,165,309; reaction of dienes with amines, for example as disclosed in DE-A 44 31 528;
enzymatic preparation of alcohols, for example as disclosed in WO 93/24644;
selective hydrogenation of dienes, for example as disclosed in U.S. Pat. No. 3,203,998, DE-A 21 41 186, GB-A 2,093,025, JP-A 02 129 24, JP-A 1 122 8468, DE-A 195 44 133, WO 94/00410, GB-A 2,260,136, DE-A 44 10 746, and JP-A 08 176 036;
preparation of alcohols from nitriles, for example as disclosed in EP-A 0 271 092;
preparation of alcohols via reaction of alkynes, for example as disclosed in RU 205 9597-C1; and
hydrogenolysis of substituted tetrahydropyrans, for example as disclosed in

Other processes for the production of alcohols are known to the person skilled in the art, and can likewise be used for the preparation of alcohols or alcohol mixtures suitable for the esterification reaction with benzenepolycarboxylic acids. Alcohols whose use is preferred are—as mentioned above—alcohols which have C₁-C₁₃-alkyl radicals, particularly preferably C₈-C₁₃-alkyl radicals. In particular the relatively long-chain C₈-C₁₃ alcohols, and alcohol mixtures which comprise these alcohols, are particularly preferably prepared via catalytic hydroformylation (also termed oxo reaction) from olefins and subsequent hydrogenation of the resultant aldehydes. Suitable hydroformylation processes are known to the person skilled in the art and are disclosed in the abovementioned documents. The alcohols and alcohol mixtures disclosed in the documents mentioned can be reacted with the abovementioned benzenepolycarboxylic acids to give the desired alkyl benzenepolycarboxylates and, respectively, alkyl benzenepolycarboxylate mixtures of the formula (I).

C₅ alcohols, and mixtures which comprise C₅ alcohols, particularly preferably n-pentanol, can by way of example be prepared via hydroformylation of butadiene in the presence of an aqueous solution of a rhodium compound and of a phosphine, as catalyst. This type of process is disclosed by way of example in EP-A 0 643 031.

Suitable C₇ alcohol mixtures which may be used for the esterification with the benzenepolycarboxylic acids are disclosed by way of example in JP-A 2000/319 444. The C₇ alcohol mixture is prepared via hydroformylation with subsequent hydrogenation of the aldehydes formed.

Mixtures comprising C₈ alcohols and processes for their preparation are disclosed by way of example in GB-A 721 540, which describes a process for the preparation of isooctyl alcohols starting from heptenes by means of hydroformylation and subsequent hydrogenation. Other documents which disclose the preparation of C₇ alcohols or of mixtures comprising these alcohols are DE-A 195 30 414, JP-A 2001/49029, U.S. Pat. No. 2,781,396, U.S. Pat. No. 3,094,564, FR-A 1,324,873, JP-A 08 169 854, U.S. Pat. No. 3,153,673, U.S. Pat. No. 3,127,451, and U.S. Pat. No. 1,828,344.

C₉ alcohols or mixtures comprising C₉ alcohols are preferably prepared via dimerization of butenes, hydroformylation of the resultant octenes, and subsequent hydrogenation of the resultant C₉ aldehyde.

Suitable processes and mixtures comprising C₉ alcohols are disclosed by way of example in WO 92/13818, DE-A 20 09 505, DE-A 199 24 339, EP-A 1 113 034, WO 2000/63151, WO 99/25668, JP-A 1 160 928, JP-A 03 083 935, JP-A 2000/053803, EP-A 0 278 407, and EP-A 1 178 029.

C₁₀ alcohols and mixtures comprising these alcohols are disclosed by way of example in WO 2003/66642, WO 2003/18912, EP-A 0 424 767, WO 2002/68369, EP-A 0 366 089, and JP-A 2001/002829.

C₁₂ alcohols or mixtures comprising C₁₂ alcohols, in particular trimethylnonanol, and a process for their preparation are disclosed by way of example in WO 98/03462.

C₁₃ alcohols, and also mixtures comprising these alcohols, are disclosed by way of example in DE-A 100 32 580, DE-A 199 55 593, and WO 2002/00580.

If the alkyl radicals R of the cyclohexanepolycarboxylic esters are C₁-C₄-alkyl radicals, these are obtained via reaction of the benzenepolycarboxylic acids of the formula II with methanol, ethanol, n-propanol, isopropanol, n-butanol, isobutanol, sec-butanol or tert-butanol. For the preparation of benzenepolycarboxylic esters where R is 3 or 4, use may be made in each case of a mixture of the propanols or butanols mentioned, or of individual isomers. It is preferable to use individual isomers of the propanol or of the butanol. The person skilled in the art is aware of the preparation of the abovementioned C₁-C₄ alcohols.

If the alkyl radicals R of the cyclohexanepolycarboxylic esters are C₅-C₁₃-alkyl radicals, preferably C₈-C₁₃-alkyl radicals, it is preferable to use C₅-C₁₃ alcohols, particularly preferably C₈-C₁₃ alcohols, with particular preference C₈, C₉, and/or C₁₀ alcohols, which have degrees of branching (ISO index) which are generally from 0.1 to 4, preferably from 0.5 to 3, particularly preferably from 0.8 to 2, and in particular from 1 to 1.5, meaning that each of the alcohols is generally a mixture of different isomers.

The ISO index is a dimensionless variable determined by means of gas chromatography.
Method: Capillary GC
Apparatus: Capillary gas chromatograph with autosampler, split/splitless injection system, and flame ionization detector (FID)
Chemicals:—MSTFA (N-methyl-N-trimethylsilyltrifluoroacetamide)
Comparisons for determining retention times

Specimen preparation: 3 drops of the specimen are kept at 80° C. for 60 minutes in 1 ml of MSTFA

GC conditions: Capillary column: Ultra-1

Length: 50 m

Internal diameter: 0.25 mm

Film thickness: 0.1 micrometer

Carrier gas: helium

Column inlet pressure: 200 psi, constant

Split: 80 ml/min

Septum flushing: 3 ml/min

Oven temperature: 120° C., 25 min, isothermic

Injector temperature: 250° C.

Detector temperature: 250° C. (FID)

Injection volume: 0.5 microliter

Calculation The following table shows the procedure for calculating the ISO index:

| | | Number of | Proportion in | |
|---|---|---|---|---|
| Component | Name | branches | % by area | Index |
| 1 | 2-ethyl-2-methyl-1- | 2 | 1.00 | 0.0200 |
| | hexanol | | | |
| 2 | 2-ethyl-4-methyl-1- | 2 | 1.00 | 0.0200 |
| | hexanol | | | |
| 3 | 2-ethyl-4-methyl-1- | 2 | 1.00 | 0.0200 |
| | hexanol | | | |
| 4 | 2-propyl-3-methyl-1- | 2 | 1.00 | 0.0200 |
| | pentanol | | | |
| 5 | 2-propyl-1-hexanol | 1 | 1.00 | 0.0100 |
| 6 | 2,5-dimethyl-1- | 2 | 1.00 | 0.0200 |
| | heptanol | | | |
| 7 | 2,3-dimethyl-1- | 2 | 1.00 | 0.0200 |
| | heptanol | | | |
| 8 | 2,3,4-trimethyl-1- | 3 | 1.00 | 0.0300 |
| | hexanol | | | |
| 9 | 2-ethyl-1-heptanol | 1 | 1.00 | 0.0100 |
| 10 | 3-ethyl-4-methyl-1- | 2 | 82.00 | 1.6400 |
| | hexanol | | | |
| 11 | 3-ethyl-1-heptanol | 1 | 1.00 | 0.0100 |
| 12 | 2-methyl-1-octanol | 1 | 1.00 | 0.0100 |
| 13 | 4,5-dimethyl-1- | 2 | 1.00 | 0.0200 |
| | heptanol | | | |
| 14 | 4,5-dimethyl-1- | 2 | 1.00 | 0.0200 |
| | heptanol | | | |
| 15 | 4-methyl-1-octanol | 1 | 1.00 | 0.0100 |
| 15a | 7-methyl-1-octanol | 1 | 1.00 | 0.0000 |
| 16 | 6-methyl-1-octanol | 1 | 1.00 | 0.0100 |
| 17 | 1-nonanol | 0 | 1.00 | 0.0000 |
| | | Total: | 99.00 | 1.9000 |
| | Unknown component | 2 | 1.00 | 0.0200 |
| | | | ISO index: | 1.9200 |

The ISO index is therefore calculated from the degree of branching of the components comprised in the alcohol mixture and from the amount of the corresponding components (determined by means of gas chromatography).

The C₅ to C₁₃ alcohols, preferably C₈-C₁₃ alcohols, are prepared by the abovementioned processes. For the preparation of cyclohexanepolycarboxylic esters in which R is C₉-alkyl, these being very particularly preferably used in the compositions of the invention, it is particularly preferable to use a nonanol mixture in which from 1 to 20% by weight, preferably from 3 to 18% by weight, particularly preferably from 5 to 16% by weight, of the nonanol mixture have no branches, from 10 to 90% by weight, preferably from 15 to 80% by weight, particularly preferably from 20 to 70% by weight, have one branch, from 5 to 40% by weight, preferably from 10 to 35% by weight, particularly preferably from 15 to 30% by weight, have two branches, from 0.1 to 10% by weight, preferably from 0.1 to 8% by weight, particularly preferably from 0.1 to 5% by weight, have three branches, and from 0 to 4% by weight, preferably from 0 to 3% by weight, particularly preferably from 0.1 to 2% by weight, are other components. Other components generally are nonanols having more than three branches, decanols, or octanols. The entirety of the components mentioned here is 100% by weight.

One particularly preferred embodiment of a nonanol mixture used for the preparation of cyclohexanepolycarboxylic acid derivatives whose use is preferred has the following composition:
from 1.73 to 3.73% by weight, preferably from 1.93 to 3.53% by weight, particularly preferably from 2.23 to 3.23% by weight, of 3-ethyl-6-methylhexanol;
from 0.38 to 1.38% by weight, preferably from 0.48 to 1.28% by weight, particularly preferably from 0.58 to 1.18% by weight, of 2,6-dimethylheptanol;
from 2.78 to 4.78% by weight, preferably from 2.98 to 4.58% by weight, particularly preferably from 3.28 to 4.28% by weight, of 3,5-dimethylheptanol;
from 6.30 to 16.30% by weight, preferably from 7.30 to 15.30% by weight, particularly preferably from 8.30 to 14.30% by weight, of 3,6-dimethylheptanol; from 5.74 to 11.74% by weight, preferably from 6.24 to 11.24% by weight, particularly preferably from 6.74 to 10.74% by weight, of 4,6-dimethylheptanol;
from 1.64 to 3.64% by weight, preferably from 1.84 to 3.44% by weight, particularly preferably from 2.14 to 3.14% by weight, of 3,4,5-trimethylhexanol;
from 1.47 to 5.47% by weight, preferably from 1.97 to 4.97% by weight, particularly preferably from 2.47 to 4.47% by weight, of 3,4,5-trimethylhexanol, 3-methyl-4-ethylhexanol, and 3-ethyl-4-methylhexanol;
from 4.00 to 10.00% by weight, preferably from 4.50 to 9.50% by weight, particularly preferably from 5.00 to 9.00% by weight, of 3,4-dimethylheptanol;
from 0.99 to 2.99% by weight, preferably from 1.19 to 2.79% by weight, particularly preferably from 1.49 to 2.49% by weight, of 4-ethyl-5-methylhexanol, and 3-ethylheptanol;
from 2.45 to 8.45% by weight, preferably from 2.95 to 7.95% by weight, particularly preferably from 3.45 to 7.45% by weight, of 4,5-dimethylheptanol, and 3-methyloctanol;
from 1.21 to 5.21% by weight, preferably from 1.71 to 4.71% by weight, particularly preferably from 2.21 to 4.21% by weight, of 4,5-dimethylheptanol;
from 1.55 to 5.55% by weight, preferably from 2.05 to 5.05% by weight, particularly preferably from 2.55 to 4.55% by weight, of 5,6-dimethylheptanol;
from 1.63 to 3.63% by weight, preferably from 1.83 to 3.43% by weight, particularly preferably from 2.13 to 3.13% by weight, of 4-methyloctanol;
from 0.98 to 2.98% by weight, preferably from 1.18 to 2.78% by weight, particularly preferably from 1.48 to 2.48% by weight, of 5-methyloctanol;
from 0.70 to 2.70% by weight, preferably from 0.90 to 2.50% by weight, particularly preferably from 1.20 to 2.20% by weight, of 3,6,6-trimethylhexanol;
from 1.96 to 3.96% by weight, preferably from 2.16 to 3.76% by weight, particularly preferably from 2.46 to 3.46% by weight, of 7-methyloctanol;
from 1.24 to 3.24% by weight, preferably from 1.44 to 3.04% by weight, particularly preferably from 1.74 to 2.74% by weight, of 6-methyloctanol;
from 25 to 35% by weight, preferably from 28 to 33% by weight, particularly preferably from 29 to 32% by weight, of other alcohols having 9 or 10 carbon atoms,
where the entirety of the components mentioned is 100% by weight.

Another particularly preferred embodiment of a nonanol mixture used for the preparation of cyclohexanepolycarboxylic acid derivatives whose use is preferred has the following composition:
from 6.0 to 16.0% by weight, preferably from 7.0 to 15.0% by weight, particularly preferably from 8.0 to 14.0% by weight, of n-nonanol;
from 12.8 to 28.8% by weight, preferably from 14.8 to 26.8% by weight, particularly preferably from 15.8 to 25.8% by weight, of 6-methyloctanol;
from 12.5 to 28.8% by weight, preferably from 14.5 to 26.5% by weight, particularly preferably from 15.5 to 25.5% by weight, of 4-methyloctanol;
from 3.3 to 7.3% by weight, preferably from 3.8 to 6.8% by weight, particularly preferably from 4.3 to 6.3% by weight, of 2-methyloctanol;
from 5.7 to 11.7% by weight, preferably from 6.3 to 11.3% by weight, particularly preferably from 6.7 to 10.7% by weight, of 3-ethylheptanol;
from 1.9 to 3.9% by weight, preferably from 2.1 to 3.7% by weight, particularly preferably from 2.4 to 3.4% by weight, of 2-ethylheptanol;
from 1.7 to 3.7% by weight, preferably from 1.9 to 3.5% by weight, particularly preferably from 2.2 to 3.2% by weight, of 2-propylhexanol;
from 3.2 to 9.2% by weight, preferably from 3.7 to 8.7% by weight, particularly preferably from 4.2 to 8.2% by weight, of 3,5-dimethylheptanol;
from 6.0 to 16.0% by weight, preferably from 7.0 to 15.0% by weight, particularly preferably from 8.0 to 14.0% by weight, of 2,5-dimethylheptanol;
from 1.8 to 3.8% by weight, preferably from 2.0 to 3.6% by weight, particularly preferably from 2.3 to 3.3% by weight, of 2,3-dimethylheptanol;
from 0.6 to 2.6% by weight, preferably from 0.8 to 2.4% by weight, particularly preferably from 1.1 to 2.1% by weight, of 3-ethyl-4-methylhexanol;
from 2.0 to 4.0% by weight, preferably from 2.2 to 3.8% by weight, particularly preferably from 2.5 to 3.5% by weight, of 2-ethyl-4-methylhexanol;
from 0.5 to 6.5% by weight, preferably from 1.5 to 6% by weight, particularly preferably from 1.5 to 5.5% by weight, of other alcohols having 9 carbon atoms;

where the entirety of the components mentioned is 100% by weight.

Diisononyl cyclohexane-1,2-dicarboxylates are therefore very particularly preferred cyclohexanepolycarboxylic acid derivatives. The isononyl radical of the diisononyl cyclohexane-1,2-dicarboxylates is preferably based on the abovementioned nonanols used for the preparation of the diisononyl cyclohexane-1,2-dicarboxylates. By way of example, the compound involved can be diisononyl cyclohexane-1,2-dicarboxylate, which is also obtainable commercially as Hexamoll® DINCH (BASF SE).

Further polymers, additives, and/or fillers and reinforcing materials (components (III), (IV), and (V))

The compositions of the invention can comprise, as further polymers (component (III)) alongside components I and II, in particular semicrystalline polyamides, semiaromatic copolyamides, polyesters, polyoxyalkylenes, polycarbonates, polyarylene sulfides, polyether ketones, and/or polyvinyl chlorides. Preferred further polymers (component (III)) are polycarbonate and polyamide. It is also possible to use a mixture of two or more of the polymers mentioned (component (III)). The amounts comprised of the further polymers (component (III)) are generally from 0 to 50% by weight, preferably from 0 to 20% by weight, particularly preferably from 0.05 to 15% by weight, in each case based on the total weight of components I and II.

The compositions of the invention can comprise, alongside components I and II, amounts of from 0 to 50% by weight, preferably from 0 to 40% by weight, particularly preferably from 0.05 to 30% by weight, in each case based on the total weight of components I and II, of additives (component (IV)) known to the person skilled in the art and conventionally used in plastics. Conventional additives IV that can be used are any of the substances which have good solubility with, or have good miscibility with, components I and/or II. Suitable additives (component (IV)) are inter alia dyes, stabilizers, lubricants, waxes, and antistatic agents.

The molding compositions of the invention can moreover comprise particulate or fibrous fillers or particulate or fibrous reinforcing materials (component (V)), in particular glass fibers and calcium carbonate, the amounts present of these mostly being from 0 to 50% by weight, preferably from 0 to 40% by weight, particularly preferably from 0.05 to 30% by weight, in each case based on the total weight of components I and II.

Production of the Compositions of the Invention

The compositions of the invention can be produced from components I and II and, if desired, further polymers (component (III)), additives (component (IV)), and/or fillers or reinforcing materials (component (V)) in any desired manner by any of the known methods. However, it is preferable that the components are blended via mixing in the melt, for example by extruding, kneading, or roll-milling of the components together, e.g. at temperatures in the range from 160 to 400° C., preferably from 180 to 280° C., where the components have, in one preferred embodiment, been previously isolated to some extent or completely from aqueous dispersions/emulsions or solutions obtained during the respective steps of the production process. By way of example, the graft copolymers A of component I can be in moist crumb form when mixed with pellets of the thermoplastic copolymer B of component I, whereupon then during the mixing process the complete drying process takes place to give the graft copolymers used as component I.

The compositions of the invention can be processed to give moldings, such as sheets or semifinished products, foils, or fibers, or else to give foams. In particular, the compositions of the invention can be used in applications in which they come into contact with foods, and also in medical products, or toys.

According to one embodiment of the invention, these products can be produced from the molding compositions of the invention by the known methods of thermoplastics processing. In particular, the production method can be thermoforming, extrusion, injection molding, calendering, blow molding, compression molding, or sintering, including pressure sintering, preferably extrusion or injection molding.

The compositions of the invention, comprising the specifically selected quantitative proportions of components A and B, and also component II, exhibit the following differences from the comparable molding compositions described in the prior art: improved flowability in the production of moldings, good or improved mechanical properties, and/or no migration of the plasticizer to the surface of corresponding moldings even at elevated temperature. Another particular advantage of the compositions of the invention is that they are used in applications in which they come into contact with foods, and also in medical products or toys.

The examples below provide further explanation of the invention.

### EXAMPLES

Test Methods

The intrinsic viscosity of the styrene co- or terpolymers was determined to DIN 53727 in 0.5% strength by weight DMF solution at 25° C.

The Charpy impact resistance of notched test specimens a_{CN} [kJ/m²] and deflection at break S_{D} [mm] were determined to DIN EN ISO 179-2/-2/1eA(F) of June 2000 at 23° C. and 50% rel. humidity.

The Izod impact resistance of notched test specimens a_{IN} [kJ/m²] was determined to DIN EN ISO 180/A(F) of April 2007.

The melt volume flow rate MVR [cm³/10 min] was determined to DIN EN ISO 1133/B of September 2005 at 220° C. with a load of 10 KP.

The Vicat softening point VSP [° C.] was determined to DIN EN ISO 306/B of October 2004.

The modulus of elasticity Eₜ [MPa], tensile strength σ_{IM} [MPa], and tensile stress at break a [MPa] were determined to DIN EN ISO 527-2 of 1993.

Flexural modulus of elasticity E_{f} [MPa] and flexural strength σ_{IM} [MPa] were determined to DIN EN ISO 178 of April 2006.

“Spiral Flow” from/to [cm] was determined to the standard T7.6.1. (spiral thickness 2 mm) at 240/60° C.

Starting Materials:

Component I-i, corresponding to a mixture of components A-i and B-i:

A commercially available acrylonitrile-butadiene-styrene copolymer (ABS), Terluran® GP 35, from BASF SE, comprising about 71% by weight of a styrene-acrylonitrile copolymer hard phase (component B-i) with IV 64 ml/g and about 29% by weight of a particulate butadiene graft rubber (component A-i); each of the % by weight values is based on the total weight of components A-i and B-i, and the total of those values is 100% by weight.

Component B-ii:

A styrene-acrylonitrile copolymer (SAN) of 76% by weight of styrene and 24% by weight of acrylonitrile, characterized by intrinsic viscosity IV 60 ml/g.

Component II-i

A commercially available diisononyl cyclohexane 1,2-dicarboxylate, CAS number: 166412-78-8, Hexamoll® DINCH, from BASF SE.

Production of Molding Compositions and Moldings:

The parts by weight specified in Table 1 of components A-i, B-i, B-ii and II-i were mixed at melt temperature from 200 to 220° C. at a screw rotation rate of 200 rpm and throughput of 10 kg/h in a twin-screw extruder, and processed directly to give test specimens. The properties specified in Table 1 were determined.

TABLE 1
Proportions by weight of components and properties of the resultant molding compositions and moldings

| Example * | Comp. 1 | 2 | 3 | 4 | Comp. 5 | Comp. 6 | Comp. 7 |
|---|---|---|---|---|---|---|---|
| Proportions by weight [% by wt.] ** | | | | | | | |
| A-i *** | 19.3 | 19.1 | 18.8 | 18.4 | 28.7 | 28.2 | 27.6 |
| B-i *** | 47.4 | 46.9 | 45.9 | 45.0 | 70.3 | 68.9 | 67.6 |
| B-ii | 33.3 | 33.0 | 32.4 | 31.8 | 0 | 0 | 0 |
| II-i | 0 | 1.0 | 2.9 | 4.8 | 1.0 | 2.9 | 4.8 |
| Proportion by weight of component A, based on | 19.3 | 19.3 | 19.3 | 19.3 | 29.0 | 29.0 | 29.0 |
| the total weight of components A and B [% by wt.] | | | | | | | |
| Properties | | | | | | | |
| Charpy impact resistance a_{cN} [kJ/m²] | 7.3 | 8.2 | 10.5 | 11.9 | 27.3 | 28.5 | 28.2 |
| Deflection at break S_{D} [mm] | 1.7 | 1.6 | 1.9 | 2.1 | 3.0 | 3.1 | 3.2 |
| Izod impact resistance a_{iN} [kJ/m²] | 5.44 | 5.43 | 8.18 | 8.94 | 20.4 | 21.5 | 21.7 |
| Melt volume flow rate MVR [cm³/10 min] | 42.5 | 48.6 | 67.7 | 87.8 | 38.7 | 46.0 | 54.8 |
| Vicat softening point VSP [° C.] | 98.5 | 96.8 | 92.3 | 89.5 | 92.3 | 89.2 | 86.6 |
| Modulus of elasticity Eₜ [MPa] | 2728 | 2703 | 2627 | 2542 | 2341 | 2285 | 2218 |
| Tensile strength σ_{M} [MPa] | 51.31 | 49.79 | 46.13 | 44.11 | 43.75 | 41.37 | 39.28 |
| Tensile stress at break σ_{B} [MPa] | 38.08 | 38.10 | 33.63 | 31.58 | 32.61 | 33.28 | 29.82 |
| Flexural modulus of elasticity E_{f} [MPa] | 2891 | 2864 | 2780 | 2692 | 2446 | 2366 | 2288 |
| Flexural strength σ_{fM} [MPa] | 77.27 | 76.20 | 70.28 | 64.63 | 65.83 | 60.73 | 56.18 |
| “Spiral Flow” from [cm]/to [cm] | 50/50 | n.d. **** | n.d. | 60.2/60.7 | n.d. | n.d. | n.d. |

* Examples marked “Comp.” are comparative examples;
** Each of the % by weight values for components A-i, B-i, B-ii and II-i is based on the total weight of these components, and the total of those values is 100% by weight.
*** Components A-i and B-i were used in premixed form (component I-i).
**** n.d. means “not determined”

The experiments confirm that the compositions of the invention, comprising the specifically selected quantitative proportions of components A and B, and also component II, exhibit the following differences from the comparable molding compositions described in the prior art: improved flowability in the production of moldings, and good mechanical properties.

1.-10. (canceled)

11. A composition comprising
(i) as component (I) at least one molding composition comprising components A and B, where
A) is a graft copolymer as component A, comprising
a1) from 30 to 90% by weight, based on component A, of a graft base obtainable via reaction of
a1.1) from 50 to 100% by weight, based on component al, of at least one conjugated diene, and
a1.2) from 0 to 50% by weight, based on component al, of at least one further monoethylenically unsaturated monomer; and
a2) from 10 to 70% by weight, based on component A, of a graft obtainable via reaction of
a2.1) from 60 to 95% by weight, based on component a2, of at least one vinylaromatic monomer,
a2.2) from 5 to 40% by weight, based on component a2, of acrylonitrile, and
a2.3) from 0 to 35% by weight, based on component a2, of at least one further monoethylenically unsaturated monomer in the presence of the graft base a1, and
B) is a thermoplastic copolymer as component B obtainable via reaction of
b1) from 60 to 100% by weight, based on component B, of at least one vinylaromatic monomer,
b2) from 0 to 40% by weight, based on component B, of acrylonitrile, and
b3) from 0 to 40% by weight, based on component B, of at least one further monoethylenically unsaturated monomer;
(ii) at least one cyclohexanepolycarboxylic acid derivative of the formula (I); as component (II) 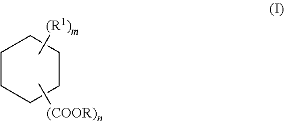
in which
R¹ is C₁-C₁₀-alkyl or C₃-C₈-cycloalkyl,
M is 0, 1, 2, or 3,
n is 2, 3, or 4, and
R is hydrogen or C₁-C₃₀-alkyl;
or
the group —(COOR)ₙ forms an anhydride of the formula 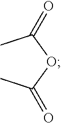
(iii) as component (III), if appropriate, one or more further polymers;
(iv) as component (IV), if appropriate, one or more additives; and
(v) as component (V), if appropriate, one or more fillers and/or reinforcing materials,
wherein component (I) comprises from 11 to 19.9% by weight of component A and from 80.1 to 89% by weight of component B, where each of the % by weight values is based on the entirety of components A and B, and the total of those values does not exceed 100% by weight.

12. The composition according to claim 11, wherein the vinylaromatic monomer of component a2.1 is styrene and/or α-methylstyrene.

13. The composition according to claim 11, wherein the vinylaromatic monomer of component b1 is styrene and/or α-methylstyrene.

14. The composition according to claim 11, comprising
(i) from 95 to 99.99% by weight of component (I);
(ii) from 0.01 to 5% by weight of component (II);
where the entirety of components I and II does not exceed 100% by weight; and
(iii) from 0 to 50% by weight, based on the total weight of components I and II, of component (III);
(iv) from 0 to 50% by weight, based on the total weight of components I and II, of component (IV); and
(v) from 0 to 50% by weight, based on the total weight of components I and II, of component (V).

15. The composition according to claim 11, wherein the definitions of components A and B are as follows:
component A:
the graft base a1 is obtainable via reaction of
from 50 to 100% by weight, based on component al, of component all, and
from 0 to 50% by weight, based on component al, of component a1.2; and
the graft a2 is obtainable via reaction of
from 60 to 95% by weight, based on component a2, of component a2.1;
from 5 to 40% by weight, based on component a2, of component a2.2; and
from 0 to 35% by weight, based on component a2, of component a2.3;
in the presence of the graft base a1; and
component B:
the thermoplastic copolymer B is obtainable via reaction of
from 60 to 100% by weight, based on component B, of component b1;
from 0 to 40% by weight, based on component B, of component b.2; and
from 0 to 40% by weight, based on component B, of component b.3.

16. The composition according to claim 11, wherein component (I) comprises
from 11 to 19% by weight of component A and
from 80.1 to 89% by weight of component B,
where each of the % by weight values is based on the entirety of components A and B, and
the total of those values does not exceed 100% by weight.

17. The composition according to claim 11, wherein component a2 is composed of components a2.1 and a2.2,
wherein:
a2.1 is styrene, α-methylstyrene, or a mixture of these compounds;
a2.2 is acrylonitrile.

18. The composition according to claim 17, wherein a2.1 is styrene.

19. The composition according to claim 11, wherein component B is composed of components b1 and b2,
where
b1 is styrene, α-methylstyrene, or a mixture of these compounds;
b2 is acrylonitrile.

20. The composition according to claim 19, wherein b1 is styrene.

21. The composition according to claim 11, wherein component (II) is at least one cyclohexane-1,2-dicarboxylic ester selected from the group consisting of diisobutyl cyclohexane-1,2-dicarboxylate, di(2-ethylhexyl)cyclohexane-1,2-dicarboxylate, diisononyl cyclohexane-1,2-dicarboxylate, and diisodecyl cyclohexane-1,2-dicarboxylate, preferably selected from the group consisting of di(2-ethylhexyl)cyclohexane-1,2-dicarboxylate and diisononyl cyclohexane-1,2-dicarboxylate.

22. The composition according to claim 21, wherein component (II) is diisononyl cyclohexane-1,2-dicarboxylate.

23. A process for producing a composition comprising
(i) as component (I) at least one molding composition comprising components A and B,
where
A) is a graft copolymer as component A, comprising
a1) from 30 to 90% by weight, based on component A, of a graft base obtainable via reaction of
a1.1) from 50 to 100% by weight, based on component al, of at least one conjugated diene, and
a1.2) from 0 to 50% by weight, based on component al, of at least one further monoethylenically unsaturated monomer, and
a2) from 10 to 70% by weight, based on component A, of a graft obtainable via reaction of
a2.1) from 60 to 95% by weight, based on component a2, of at least one vinylaromatic monomer,
a2.2) from 5 to 40% by weight, based on component a2, of acrylonitrile, and
a2.3) from 0 to 35% by weight, based on component a2, of at least one further monoethylenically unsaturated monomer in the presence of the graft base a1, and
B) is a thermoplastic copolymer as component B obtainable via reaction of
b1) from 60 to 100% by weight, based on component B, of at least one vinylaromatic monomer,
b2) from 0 to 40% by weight, based on component B, of acrylonitrile, and
b3) from 0 to 40% by weight, based on component B, of at least one further monoethylenically unsaturated monomer;
(ii) at least one cyclohexanepolycarboxylic acid derivative of the formula (I); as component (II) 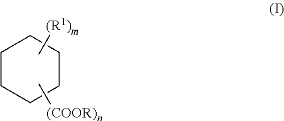
in which
R¹ is C₁-C₁₀-alkyl or C₃-C₈-cycloalkyl,
m is 0, 1, 2, or 3,
n is 2, 3, or 4, and
R is hydrogen or C₁-C₃₀-alkyl;
or
the group —(COOR)ₙ forms an anhydride of the formula 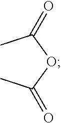
(iii) as component (III), if appropriate, one or more further polymers;
(iv) as component (IV), if appropriate, one or more additives; and
(v) as component (V), if appropriate, one or more fillers and/or reinforcing materials,
wherein component (I) comprises from 11 to 19.9% by weight of component A and from 80.1 to 89% by weight of component B, where each of the % by weight values is based on the entirety of components A and B, and the total of those values does not exceed 100% by weight;
the process comprising mixing components (I), (II) and, if appropriate, (III) and, if appropriate, (IV) and, if appropriate, (V), in the melt.

24. The process according to claim 23, wherein a2.1 is styrene and/or α-methylstyrene.

25. The process according to claim 23, wherein b1 is styrene and/or α-methylstyrene.

26. A method for producing moldings, foils, foams, or fibers comprising utilizing the composition according to claim 11.

27. A molding, a foil, a foam, or a fiber comprising the composition according to claim 11.
